(19) United States
(12) Patent Application Publication
(10) Pub. No.: US 2025/0155560 A1
(43) Pub. Date: May 15, 2025

(54) TIME-OF-FLIGHT DETECTION CIRCUITRY AND TIME-OF-FLIGHT DETECTION METHOD

(71) Applicant: Sony Semiconductor Solutions Corporation, Kanagawa (JP)

(72) Inventors: Renato FERRACINI ALVES, Stuttgart (DE); Valerio CAMBARERI, Stuttgart (DE)

(73) Assignee: Sony Semiconductor Solutions Corporation, Kanagawa (JP)

(21) Appl. No.: 18/715,156

(22) PCT Filed: Nov. 14, 2022
(86) PCT No.: PCT/EP2022/081848

§ 371 Date: May 31, 2024

(30) Foreign Application Priority Data
Dec. 9, 2021 (EP) 21213380.5

(51) Int. Cl. G01S 7/493; G01S 7/4914; G01S 7/4915; G01S 17/36; G01S 17/894

(52) U.S. Cl. CPC G01S 7/493; G01S 7/4914; G01S 7/4915; G01S 17/36; G01S 17/894

(57) ABSTRACT

The present disclosure generally pertains time-of-flight detection circuitry configured to determine a single-frame noise estimate based on a common mode estimator and a dark frame measurement, and to perform filtering of depth data based on the single-frame noise estimate.

### TECHNICAL FIELD

The present disclosure generally pertains to time-of-flight detection circuitry and a time-of-flight detection method.

### TECHNICAL BACKGROUND

Time-of-flight (ToF) systems are generally known. Such systems may attempt to measure a distance based on a roundtrip delay of light. There are different methods for measuring such a roundtrip delay. For example, indirect time-of-flight (iToF) may determine the roundtrip delay based on a modulation phase-shift between emitted light and detected light.

Among other ToF illumination patterns, spot ToF is known by which the ToF system may use an illuminator shining a sparse set of light beams, for determining a phase-shift, as well, and extracting other information on sparse scene locations captured this way.

Measurement artifacts may be present, e.g., due to scattered light, multi-path interference, or the like, which may contribute to systematic measurement error of iToF systems.

There are known methods for reducing such artifacts and thus, the systematic error, such as direct-global separation.

Moreover, iToF is affected by non-systematic, random sensor noise following known probabilistic models (shot noise, readout noise).

There are known methods for mitigating the impact of sensor noise, such as invalidating depth map values, data denoising, or the like.

Although there exist techniques to mitigate systematic error and random sensor noise in time-of-flight data, it is generally desirable to provide time-of-flight detection circuitry and a time-of-flight method.

### SUMMARY

According to a first aspect, the disclosure provides time-of-flight detection circuitry configured to determine a single-frame noise estimate based on a common mode estimator and a dark frame measurement, and to perform filtering of depth data based on the single-frame noise estimate.

According to a second aspect, the disclosure provides a time-of-flight detection method comprising:
determining a single-frame noise estimate based on a common mode estimator and a dark frame measurement;
and filtering of depth data based on the single-frame noise estimate. Further aspects are set forth in the dependent claims, the following description, and the drawings.

### BRIEF DESCRIPTION OF THE DRAWINGS

Embodiments are explained by way of example with respect to the accompanying drawings, in which:

FIG. 1 is an illustrational example of a spot ToF system and illustrates how light may be incident on a sensor;

FIG. 2 depicts an embodiment of a ToF data path schematic according to the present disclosure;

FIG. 3 depicts a comparison of a single-frame SNR estimator output against a measured SNR (on the left), and a comparison result (on the right);

FIG. 4 shows a spot ToF image (middle), a pattern of spot regions (right), and a pattern of valley regions (left);

FIG. 5. is an illustrational example for explaining the principles of direct-global separation (DGS);

FIG. 6 depicts a phase noise as a function of signal-to-noise ratio (SNR);

FIG. 7 shows an application example of a selective DGS filter according to the present disclosure;

FIG. 8 depicts an illustration of an effect of a precision filter according to the present disclosure;

FIG. 9a depicts an illustration of an effect of a noise-modelled bilateral filter according to the present disclosure;

FIG. 9b depicts another illustration of an effect of a noise-modelled bilateral filter according to the present disclosure;

FIG. 10 depicts an embodiment of a ToF detection method according to the present disclosure;

FIG. 11 depicts a further embodiment of a ToF detection method according to the present disclosure in which subsequent filtering is carried out;

FIG. 12 depicts a further embodiment of a ToF detection method according to the present disclosure in which a total light signal is determined and a dark-frame measurement is removed;

FIG. 13 schematically show the operational principle of an iToF system according to the present disclosure; and

FIG. 14 schematically depicts an embodiment of an iToF device including ToF detection circuitry according to the present disclosure.

### DETAILED DESCRIPTION OF EMBODIMENTS

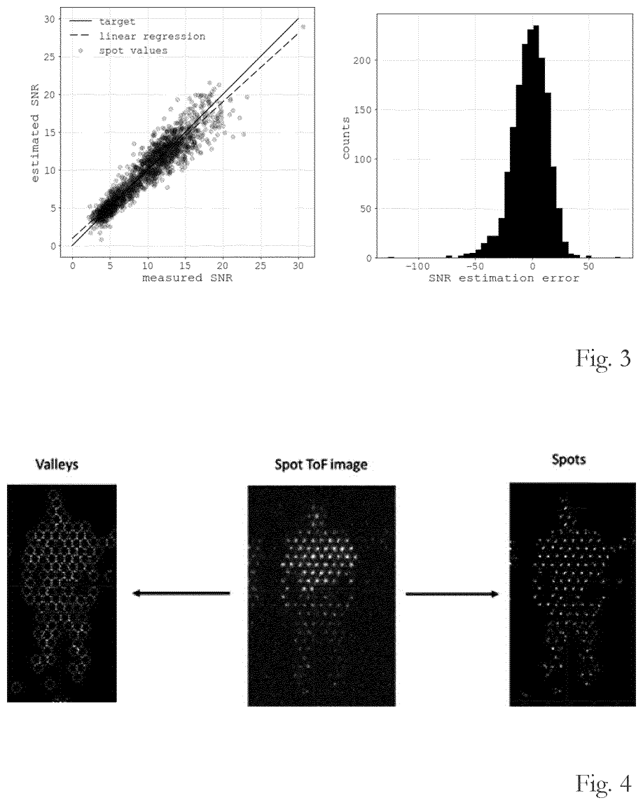

Before a detailed description of the embodiments starting with FIG. 2 is given, general explanations are made concerning the ToF systems/circuitry/devices/methods addressed by the present disclosure.

As mentioned in the outset, time-of-flight (ToF) systems are generally known. For example, spot ToF may illuminate a scene with a light pattern of (separated) high-intensity and low-intensity light areas such as, for example, a pattern of light beams (which, when observed from a ToF system, will form a dot pattern).

In spot ToF systems, the light for illuminating the scene may be concentrated (or focused) in the (center of the) light spots. Part of the light concentrated in the light spots may be backscattered/reflected (or in any other way deviated from an “ideal” light path) from e.g., objects in the scene. A fraction of this reflected light may be captured by a camera lens and may generate an image of the scene in a sensor array. Nevertheless, multiple reflections and scattering on a receiver side of the spot ToF system (camera lens, optical filter and sensor) may cause the light that was supposed to be focused on a particular region of the sensor array to spread to neighboring regions.

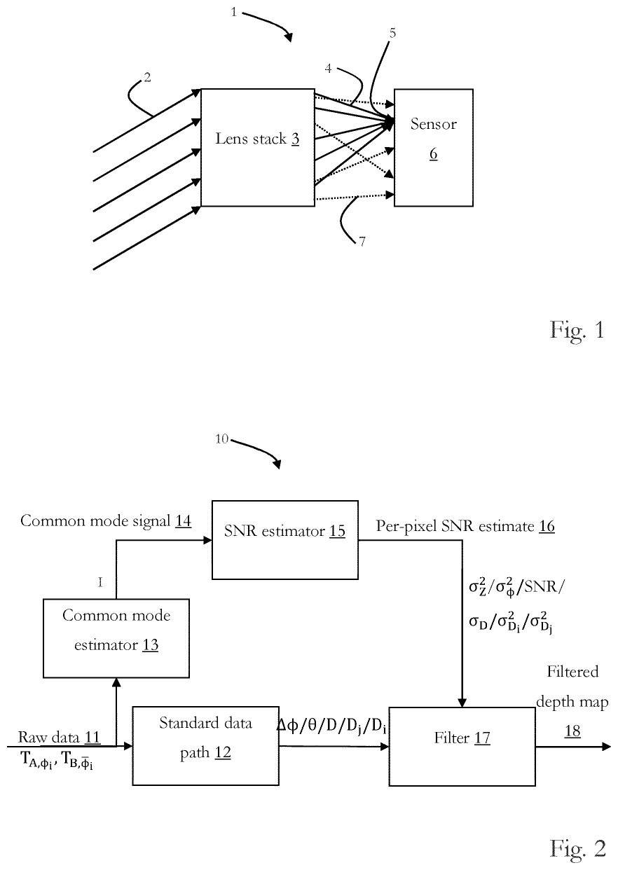

FIG. 1 is an illustrational example of a spot ToF system 1 and illustrates how light may be incident on a sensor when a single angle of view should be imaged in a single point in an imaging plane, but part of the optical power contained in that particular direction is spread over the sensor array.

Parallel light 2 depicting the single angle of view is incident on a lens stack 3 configured to focus the incident light. Focused light 4 is then incident on a point 5 of a sensor 6. However, also stray light 7 is incident on the sensor 6, such that the image which is obtained with the sensor 6 does not only image the focused light 4, but also the stray light 7.

In the following, spread energy contribution will be referred to as global component, and focused light energy contribution will be referred to as direct component of a received signal.

Multiple reflections in a scene may also cause similar interference as depicted in FIG. 1. This may be known as multi path interference (MPI), which may spread the light from a single point on an image over the sensor, contributing to the global component.

In indirect ToF (iToF), in which a distance measurement may be carried out based on a modulation phase-shift of emitted light compared to detected light, a scene may be uniformly illuminated (e.g., “flash” illumination), such that it may be challenging to remove measurement errors caused by the global component.

In spot ToF, a sparse light pattern may be used to probe and compensate for the global component interference. However, the present disclosure is not limited to spot ToF, as will be discussed further below.

It has been recognized that estimating a signal-to-noise ratio (SNR) may be helpful in filtering ToF data. Further, it has been recognized that known SNR estimators may depend on ToF data of multiple frames, such that it may be desirable to provide an SNR estimator for removing noise in single-frame data, as opposed to estimating noise properties from, e.g., spatial heuristics or multiple frames.

Moreover, it has been recognized that it is desirable to provide a noise estimate, such that subsequent (downstream) filtering, such as selective direct-global separation, precision filtering, adaptive denoising, or the like, may be carried out.

It has further been recognized that known methods for reducing noise in ToF data may not be applicable to single-frame measurements and thus may increase complexity of a ToF algorithm.

For example, in the context of (known) direct-global separation (DGS) algorithms, it has been recognized that it should only be applied when a trueness gain compensates a loss of precision, i.e., when the SNR is high enough for estimating a direct component with negligible amount of superimposed noise. If no SNR estimate is at hand, DGS may significantly increase noise in the process of reducing systematic error, such that a depth map quality may be decreased. It has been recognized that it may be sufficient to apply DGS only in such parts of a spot ToF depth map where the SNR is below a predetermined threshold.

Moreover, it may be known in ToF and other depth sensing systems that depth map values can be invalidated (i.e., removed) based on a signal amplitude or any other quantity related to a confidence estimate (which may refer to, e.g., a measure of how reliable the measured depth is). However, it has been recognized that different signal amplitudes may not necessarily correspond to the same SNR. For example, when a ToF system is used outdoors, a high amount of ambient light may be present, such that a signal amplitude may be relatively large, but the SNR might be relatively low by influence of ambient light. Conversely, the ToF signal amplitude may be low but, in absence of ambient light, the SNR may be high, such that invalidation of depth map points may be avoided in such circumstances.

In the case of adaptive denoising, smoothing parameters may be set as a constant value by predefined filter configurations (“presets”), which may be changed depending on the use-case and may not be easily changed in mixed conditions (e.g., moving from outdoor to indoor sensing). This may cause a filter configuration to perform sub-optimally when the use-case is not consistent with the preset.

Smoothing parameters may also be set as a value depending on heuristics, such as signal amplitude or proportionally to depth. This may lead to a similar result as for the invalidation of depth maps, namely inconsistencies between the signal amplitude and the actual SNR, which may cause under-or over-smoothing of parts of the depth map.

Thus, using an SNR estimate (and/or functions of it, e.g., depth noise variance) may provide a more reliable tuning of smoothing parameters in denoising filters.

Therefore, some embodiments pertain to time-of-flight detection circuitry configured to determine a single-frame noise estimate based on a common mode estimator and a dark frame measurement, and to perform filtering of depth data on the single-frame noise estimate.

Depth data may for example be any data that represents depth information obtained from a time-of-flight sensor, such as phase data that is indicative of depth, or any depth information obtained from phase data, or the like. The depth data may be dense data, i.e., data for which the full sensor resolution (i.e., all pixels) yields depth information, or sparse data, i.e., data for which only a small number of pixels (or generally, a subset of all pixels) in a known sparse pattern yields depth information.

In some embodiments, the depth data is obtained from sensor raw data (for example tap data, phase angle data, or the like).

Some embodiments pertain to time-of-flight detection circuitry configured to estimate noise in time-of-flight data, the time-of-flight data being indicative of one time-of-flight signal frame, wherein the estimation is based on a predetermined estimator in an estimator data path, which is provided in parallel to a standard data path, for subsequent filtering of the time-of-flight data based on an output of the standard data path and on an output of the estimator data path.

In the present disclosure, circuitry may be any entity or multitude of entities which may be configurable for providing at least two data paths in parallel, such that time-of-flight data may be processed therein. Circuitry according to the present disclosure may be adapted to determine a single-frame noise estimate, a common mode estimate, to evaluate a dark frame measurement, and to carry out a filtering as it will be described below. The circuitry may include at least one processor (e.g. CPU (central processing unit), GPU (graphics processing unit)), FPGA (field-programmable gate array), or the like. Moreover, the circuitry may include a computer, a camera, a server, or the like.

Parallel may refer to a synchronous processing of the two data paths based on the same input (e.g. raw data), wherein the respective outputs of the data paths are input to a common process (e.g. a filter), such as two parallel lines in an electronic schematic.

The noise may be any type of systematic error which may be caused by MPI, scattering, or the like. It may include random noise (e.g. white noise, pink noise, or the like), sensor noise, or the like.

A signal frame may correspond to a predetermined amount of time in which a ToF signal is obtained. It may correspond to a measurement time, an illumination time, or the like, as it is generally known.

In a dark-frame measurement, a dark frame image may be captured with a ToF sensor in complete darkness (e.g., with a closed shutter and/or the lens and viewfinder capped). Such a dark frame may be indicative of fixed-pattern, non-random noise produced by the sensor. A dark frame, or an average of several dark frames may then be subtracted from subsequent images common mode images to correct for fixed-pattern noise.

The dark frame measurement may be carried out during a calibration phase and/or based on a “shutter-off”-measurement, such that it may be ensured that only offsets are measured. It may be sufficient to carry out only one dark frame measurement.

In more general terms, a dark frame measurement may be used to remove data from taps (e.g., from common mode data, constant data, non-modulated data, or the like), wherein the data may represent a pattern which is generated due to (fixed) pattern noise.

When a ToF measurement is carried out (after the dark frame measurement), a signal may be derived representing, e.g., a common mode, a total signal, or the like, based on a sum of the tap values, which may be indicative of constant signal parts, which may be indicative of ambient light and the offsets, which may be removed based on the dark frame measurement.

In some embodiments, the time-of-flight detection circuitry is further configured to determine a total signal of a frame based on the common mode estimator of a frame and the dark frame measurement, and to determine the single-frame noise estimate based on the total signal of the frame, as will be discussed below.

In some embodiments, the single-frame noise estimate is represented by a single-frame signal-to-noise ratio, by a depth noise standard deviation, or by a phasor variance, e.g., given per pixel coordinate as will be discussed below.

In some embodiments, the time-of-flight detection circuitry is further configured to filter the time-of-flight data. The present disclosure is not limited to any type of filter. In the following, exemplary filters are used which accommodate for different objectives (or circumstances) described hereafter, but the skilled person may adapt those filters or use other filters instead according to the objectives.

In some embodiments, the time-of-flight detection is further configured to apply a direct global separation filter (DGS filter), a precision filter, a noise-modeled bilateral filter, or the like.

Generally, although different filtering methods are described herein, their common aspect may be considered as the filters being a function of an SNR estimate which is provided as input. It has been recognized that, based on the filtering, systematic error and/or random sensor noise can be mitigated. As discussed herein, according to the present disclosure, a single-frame SNR estimate may be obtained as filter input, as opposed to an SNR estimate based on multiple frames, in which case filtering may be carried out in a post processing stage, for example.

In some embodiments, the direct-global separation filtering comprises filtering of the depth data based on the single-frame noise estimate, as will be discussed below.

In some embodiments, the direct-global separation filtering comprises determining an accuracy, as will be discussed below.

In some embodiments, the accuracy is determined based on a trueness value and based on the depth noise standard deviation, as will be discussed below.

In some embodiments, the direct-global separation filtering is carried out based on a comparison of the accuracy without direct-global separation against the accuracy with direct-global separation, as will be discussed below.

In some embodiments, the precision filtering comprises filtering of the depth data based on the single-frame noise estimate, as will be discussed below.

In some embodiments, the precision filter is applied based on a precision estimate, as will be discussed below.

In some embodiments, the precision estimate is based on a relation between the depth noise standard deviation and the depth data, as will be discussed below.

In some embodiments, the precision filtering comprises invalidating a depth value, which is indicated by the depth data, if the precision estimate is below a predetermined threshold, as will be discussed below.

In some embodiments, the noise-modelled bilateral filtering comprises determining a denoised depth value based on a similarity, as will be discussed below.

In some embodiments, the similarity is determined based on a weighted average of neighboring pixels in a predetermined radius, as will be discussed below.

In some embodiments, the similarity is further determined based on the single-frame noise estimate.

Some embodiments pertain to a time-of-flight detection method including: determining a single-frame noise estimate based on a common mode estimator and a dark frame measurement; and filtering of depth data based on the single-frame noise estimate, as discussed herein.

The ToF detection method may be carried out by ToF detection circuitry according to the present disclosure.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

### Data Path Diagram

FIG. 2 depicts an exemplary embodiment of a data path schematic 10 according to the present disclosure that may be implemented by ToF detection circuitry of the embodiments.

Raw data 11 of an iToF sensor (not shown) is received by a standard data path 12 (e.g. full-field or spot ToF data path). The standard data path 12 generates a depth map from the sensor raw data. The raw data 11 is further fed into a common mode estimator. The common mode estimator 13 outputs a common mode signal 14, which is fed into an SNR estimator 15. The SNR estimator 15 is configured to determine a per-pixel single-frame SNR estimate 16. A filter 17 receives a depth map from the standard data path 12 and the per-pixel SNR estimate 16 from SNR estimator 15, and is configured to output a filtered depth map based on the per-pixel SNR estimate 16 and the depth map of the standard data path 12.

Although under reference of FIG. 2, it is described that a per-pixel single frame SNR estimate is determined, it should be noted that in case of sparse data an SNR estimate for multiple pixels may be determined accordingly, e.g. by integrating over multiple pixels.

### Sensor Raw Data

In the embodiments described below, the sensor raw data includes the tap values of a CAPD (current-assisted photonic demodulator) sensor, for example, for four or more measured components. With more components, the equations may be generalized. Moreover, they may also be generalized using more complex waveform models. In this disclosure, for simplicity, only the simplest (known) equations are presented, but it should be understood that the present disclosure is not limited in that regard since any type of raw data may be used.

The simplified tap equations (without harmonics, using pure sinusoidal illumination to see dependencies between terms to obtain practical estimators) are:

$${T}_{A , {ϕ}_{i}} := κ [ αcos ( θ + {ϕ}_{i} ) + S + {ν}_{A} ] + {O}_{A} , \\ {T}_{B , {ϕ}_{i}} := κ [ - α cos ( θ + {ϕ}_{i} ) + S + {ν}_{B} ] + {O}_{B} \qquad ( 1 )$$

with signal amplitude α, and signal offset S (comprised of ambient light and DC component), tap offsets O_{A} and O_{B}, additive system noise ν_{A}, ν_{B}˜ [symbol] (0, σ_{sys}²), at phases ϕᵢ and for a phase delay θ, and conversion gain κ.

Statistically, if we approximate shot noise to a normal distribution (i.e., as valid for the high photon counts regime (e.g. more than a thousand or more than ten thousands)) and assume a normal distribution to system noise, we can write the tap values' distribution as:

$$T {.}_{, {ϕ}_{i}} ∼ 𝒩 ( κ [ \pm αcos ( θ + {ϕ}_{i} ) + S ] + O . , {κ}^{2} [ \pm α cos ( θ + {ϕ}_{i} ) + S ] + {κ}^{2} {σ}_{s y s}^{2} ) . \qquad ( 2 )$$

Here, the dot means that this holds (with the appropriate signs and phases) for tap A or tap B.

### Standard Data Path

The standard data path processes Raw Data (which will be explained further below) to calculate a phase difference of the received light signal and a pixel demodulation signal (in the case of iToF). The calculated phase is then translated into a depth estimation, as it is generally known. Hence, the standard data path corresponds to a data path configured to process time-of-flight data and/or depth data as it is generally known.

By using the tap values, differential mode components are calculated:

$${q}_{{ϕ}_{i}} := {T}_{A , {ϕ}_{i}} - {T}_{B , {ϕ}_{i}} ∼ 𝒩 ( 2 καcos ( θ + {ϕ}_{i} ) + {O}_{A} - {O}_{B} , 2 {κ}^{2} S + 2 {κ}^{2} {σ}_{s y s}^{2} ) \qquad ( 3 )$$

Then, we define a phasor Z:=Z_{I}+jZ_{Q}, where:

$${Z}_{I} := {q}_{0} - {q}_{180} ∼ 𝒩 ( 4 καcos θ , 4 {κ}^{2} S + 4 {κ}^{2} {σ}_{s y s}^{2} ) \qquad ( 4 )$$

$${Z}_{Q} := {q}_{90} - {q}_{270} ∼ 𝒩 ( 4 καsin θ , 4 {κ}^{2} S + 4 {κ}^{2} {σ}_{s y s}^{2} ) \qquad ( 5 )$$

which yield the complex Gaussian random variable Z˜ [symbol] (μ_{α}(cos θ+j sin θ), 8κ²S+8κ²σ_{sys}²) with mean amplitude μ_{α}:=4κα. Note that the real and imaginary parts have, in this simplified model, equal variance σ_{Z}²:=4κ²S+4κ²σ_{sys}²

Depth is then calculated by mapping the phasor angle θ∈[0, 2π] to an unambiguous range D∈

$$[ 0 , \frac{c}{2 {f}_{mod}} ] .$$

### Common Mode Estimation

The common mode estimator as described below sums tap values of each component (in the case of iToF using tap values). It provides a total (light) signal received by the sensor in one component integration time:

$${a}_{{ϕ}_{i}} := {T}_{A , {ϕ}_{i}} + {T}_{B , {ϕ}_{i}} ∼ 𝒩 ( 2 κ S + {O}_{A} + {O}_{B} , 2 {κ}^{2} S + 2 {κ}^{2} {σ}_{s y s}^{2} ) \qquad ( 6 )$$

The total signal (or intensity), as obtained by removing the dark-frame measurement (as discussed above) is:

$$I := {\sum }_{i ∈ [ 4 ]} {a}_{{ϕ}_{i}} - 4 {0}_{dark} ∼ 𝒩 ( {μ}_{I} , 8 {κ}^{2} S + 8 {κ}^{2} {σ}_{s y s}^{2} ) \qquad ( 7 )$$

where the dark-frame measurement is indicated by O_{dark}≅O_{A}+O_{B}, and where the mean μ_{I}˜8κS.

### SNR Estimation

Based on equation (7), a phasor variance is estimated, if the conversion gain κ and the system noise standard deviation σ_{sys} are known. The real and imaginary parts' variance σ_{Z}² is then given by:

$${σ}_{Z}^{2} := 4 {κ}^{2} S + 4 {κ}^{2} {σ}_{s y s}^{2} = κ \frac{{μ}_{I}}{2} + 4 {κ}^{2} {σ}_{s y s}^{2} \qquad ( 8 )$$

Defining SNR=μ_{α}/σ_{Z}, if SNR>5 the depth noise standard deviation can be approximated by:

$${σ}_{D} = \frac{c}{4 π {f}_{m}} \frac{1}{S N R} \qquad ( 9 )$$

Accordingly, in some embodiments, the time-of-flight detection circuitry is further configured to determine a total signal of a frame based on the common mode estimator of a frame (i.e. a single frame for which the single-frame noise estimate is carried out) and the dark frame measurement, and to determine the single-frame noise estimate based on the total signal of the frame.

In the following, exemplary embodiments of an SNR estimator which are based on a single-frame estimator (see 15 in FIG. 2) are discussed.

The exemplifying single-frame estimator is based on instantaneous measurements of phasor amplitude Â and total signal Î. Note that the total signal may be obtained by performing a dark frame measurement, that may allow for estimating offsets and gains for obtaining Î. The single-frame SNR estimate may be obtained based on a dark-frame measurement.

$$= \sqrt{κ \frac{\hat{I}}{2} + 4 {κ}^{2} {σ}_{s y s}^{2}} \qquad ( 10 )$$

$$= \frac{c}{4 π {f}_{m}} \cdot \frac{\sqrt{κ \frac{\hat{I}}{2} + 4 {κ}^{2} {σ}_{s y s}^{2}}}{\hat{A}} \qquad ( 11 )$$

Equations 8 and 9 serve as a basis for obtaining the SNR estimate according to the present disclosure since they represent a noise model used in the SNR estimator 15 of FIG. 2.

The estimator may also pool neighboring values (i.e., of neighboring pixels) to refine the SNR estimate.

FIG. 3 depicts, on the left, a comparison of a single-frame SNR estimator output against a measured SNR, with the measurement being on three hundred frames of a static scene with a variety of SNR levels. On the right, FIG. 3 shows the results of this comparison. The SNR estimation in this case has an SNR trueness of 2% and an SNR precision of 16% (given by the standard deviation), wherein trueness and precision are defined herein according to ISO 5725 (December 2019), in which the accuracy of a measurement method can be described by two parameters: “trueness” and “precision”. “Trueness” refers to the closeness of agreement between the arithmetic mean of a large number of test results and the true or accepted reference value. “Precision” refers to the closeness of agreement between test results.

In other words, in some embodiments, the single-frame noise estimate is represented by a single-frame signal-to-noise ratio, by a depth noise standard deviation or variance, and/or by a phasor variance, as discussed above.

In some embodiments, filtering algorithms are provided which accommodate for such errors in SNR estimation, which will be described in the following.

### DGS Filtering

A DGS filter may be used according to the following circumstance:

Spot Time-of-Flight (spot ToF) systems may illuminate a scene with a light pattern of (separated) high-intensity and low-intensity light areas such as, for example, a spot pattern (e.g., light dots). Generally, in spot ToF systems the light for illuminating the scene may concentrated at the center location of the light spots, but part of the light concentrated in the light spots may be backscattered/reflected from the objects in the scene. A fraction of this light may be correctly captured by a camera lens which may create an image on a sensor array. Nevertheless, multiple reflections and stray light on a receiver side of the Spot ToF system (camera lens, optical filter, sensor, etc.) may cause part of the light that was supposed to be focused on a particular region of the sensor array to spread and affect neighboring regions, as already laid out in FIG. 1.

As shown in FIG. 4, a spot ToF image (middle) shows a pattern of “spot” pixel regions (right) and “valley” pixel regions (left). Spot pixel regions may have a higher light intensity than valley pixel regions, and may be based on a superposition of the direct and the global component signal, in addition to noise following the usual noise model in ToF systems. In FIG. 4 high intensity spot pixels are separated from the low-intensity spot valley pixels. Valley pixels are conversely based on the global component only, plus noise following a noise model in ToF systems.

A DGS filter may compensate for the global component.

Denoting with Z the ToF phasor image as obtained from raw data, Z_{direct} is estimated at a spot coordinate, by measuring the spot Zₛₚₒₜ≈Z_{direct}+Z_{global}+Z_{noise,spot} and the neighboring valleys Z_{valley}≈Z_{global}+Z_{noise,valley}. It follows that Z_{direct}≈Zₛₚₒₜ−Z_{valley} where the estimate quality depends on Z_{global} being a lowpass signal, so that the measurement of MPI at the valleys is consistent with that on the spots.

The noise in the spot and valleys may be removed or correctly accounted for in the estimation of Z_{direct}. For example, if the noise energy is larger than the direct signal energy, one will not be able to measure the direct component via DGS, and this will only result in injecting more noise in resulting phasors.

In contrast to known systems using DGS, which add noise to the computed phasors in the subtraction of valleys, using DGS according to the present disclosure may account for noise since it may estimate when systematic error caused by the global component can be removed as a function of the SNR. Moreover, a DGS algorithm according to the present disclosure may provide improved reliability and large dynamic range. The DGS filter may then be applied when a trueness correction of DGS may compensate for a decrease in precision, as will be discussed in the following.

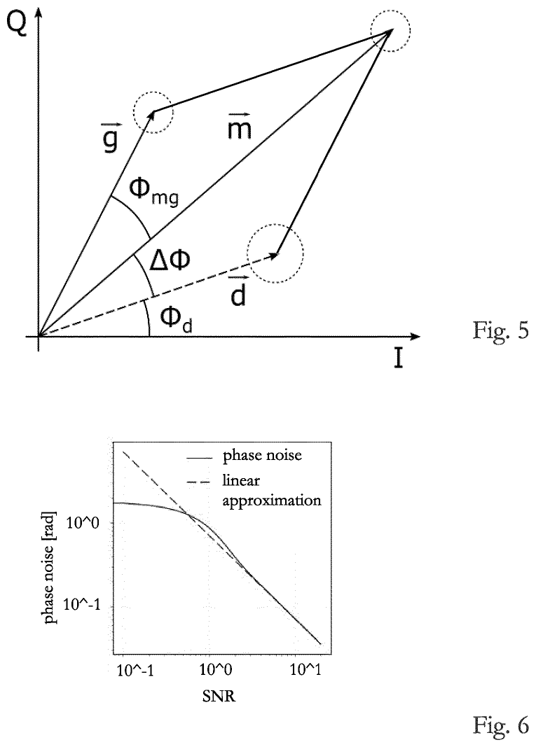

FIGS. 5 to 7 are illustrational figures for explaining a DGS filter according to the present disclosure. As depicted in FIG. 5, in DGS, a measurement of a point of interest in a scene \vec{m}˜ [symbol] ( [symbol] \vec{m} [symbol] ),σₘ²), and a measurement of the global component \vec{g}˜ [symbol] ( [symbol] \vec{g} [symbol] , σ_{g}²) is carried out. These two measurements are then used to calculate a (true) value of phasor, to which it is referred to as direct component, given by \vec{d}=\vec{m}−\vec{g}˜ [symbol] ( [symbol] \vec{m}−\vec{g} [symbol] , σₘ²+σ_{g}²).

The measurements can be expressed in terms of their IQ components (which are generally known),

$$\vec{m} = [ \begin{matrix}{I}_{m} \\ {Q}_{m}\end{matrix} ] and \vec{g} = [ \begin{matrix}{I}_{q} \\ {Q}_{g}\end{matrix} ] , \qquad ( 12 )$$

based on which a trueness error of calculating ϕ_{d} only using the measurement \vec{m} is carried out, which is

$$Δ ϕ = {ϕ}_{m} - {ϕ}_{d} = arctan ( \frac{{Q}_{m}}{{I}_{m}} ) - arctan ( \frac{{Q}_{m} - {Q}_{g}}{{I}_{m} - {I}_{g}} ) \qquad ( 13 )$$

The precision of ϕ depends on the SNR of the norm of the vector of the corresponding angle, which is given by

$${SNR}_{m} = \frac{\vert \vec{m} \vert}{{σ}_{m}} and {SNR}_{d} = \frac{\vert \vec{m} - \vec{g} \vert}{\sqrt{{σ}_{m}^{2} + {σ}_{g}^{2}}} \qquad ( 14 )$$

A corresponding probability density function (PDF) is given by

$$f ( ϕ \vert SNR ) = \frac{1}{2 π} exp ( - \frac{{SNR}^{2}}{2} ) \{ 1 + SNR \sqrt{π} \frac{cos ( ϕ )}{\sqrt{2}} exp [ {( \frac{SNR cos ( ϕ )}{\sqrt{2}} )}^{2} ] [ 1 + erf ( \frac{SNR cos ( ϕ )}{\sqrt{2}} ) ] \} \qquad ( 15 )$$

with a corresponding variance:

$${{σ}_{ϕ} ( SNR )}^{2} = \int {ϕ}^{2} f ( ϕ \vert SNR ) d ϕ \qquad ( 16 )$$

For an arbitrary value of SNR, this equation can be integrated numerically, in some embodiments. As previously mentioned, for SNR>5, equation (16) can be approximated to:

$${σ}_{ϕ}^{2} = \frac{1}{{SNR}^{2}} \qquad ( 17 )$$

FIG. 6 depicts a phase noise as a function of the SNR and its linear approximation for SNR>5.

According to the present disclosure, an accuracy error is defined. In some embodiments, three times the standard deviation of the precision is added to the trueness. The accuracy is then given by

$${acc}_{ϕ} = \vert Δϕ \vert + γ \times {σ}_{ϕ} \qquad ( 18 )$$

where γ is a parameter used to compose trueness and precision to give a measure of the accuracy error. In some embodiments, γ=3, which means only ≈0.15% of the measurements have a deviation from the true value bigger than the accuracy error.

Therefore, the determination of ϕ_{d} with and without DGS correction is given by

$${acc}_{ϕ}^{No DGS} ( {I}_{m} , {Q}_{m} , {I}_{g} , {Q}_{g} , {σ}_{m} ) = \vert arctan \frac{{Q}_{m}}{{I}_{m}} - arctan \frac{{Q}_{m} - {Q}_{g}}{{I}_{m} - {I}_{g}} \vert + γ \times {σ}_{ϕ} ( \frac{\sqrt{{I}_{m}^{2} + {Q}_{m}^{2}}}{{σ}_{m}} ) \qquad ( 19 )$$

$${acc}_{ϕ}^{D G S} ( {I}_{m} , {Q}_{m} , {I}_{g} , {Q}_{g} , {σ}_{m} , {σ}_{g} ) = γ \times {σ}_{ϕ} ( \frac{\sqrt{{( {I}_{m} - {I}_{g} )}^{2} + {( {Q}_{m} - {Q}_{g} )}^{2}}}{\sqrt{{σ}_{m}^{2} + {σ}_{g}^{2}}} ) \qquad ( 20 )$$

The IQ components are known as they derive directly from measurements. Nevertheless, in known systems, the noise may not be measured in a single frame and the determination of single-frame noise may be based on an SNR estimator, as discussed herein.

The selective DGS filter uses a ratio acc_{ϕ}^{NoDGS}/acc_{ϕ}^{DGS} to determine whether applying DGS is beneficial.

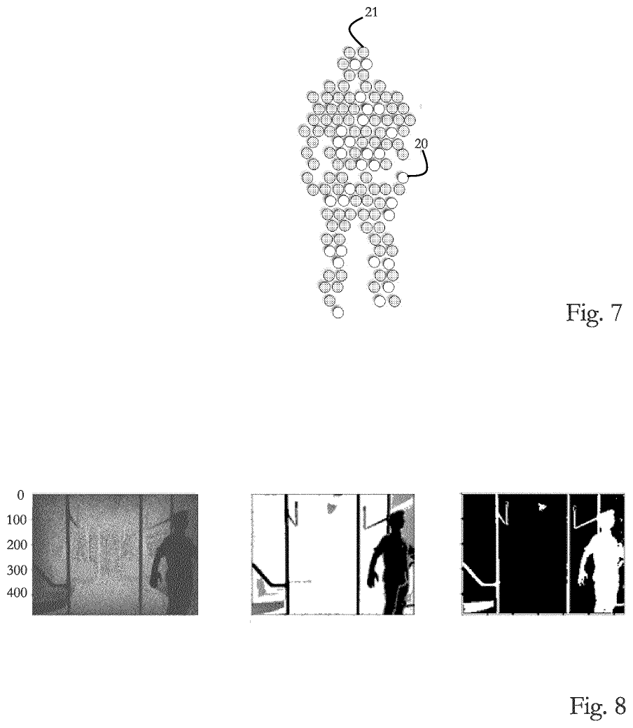

FIG. 7 shows an example of the application of the selective DGS filter. For each spot measured by the spot ToF system, it calculates whether DGS should (white dots 20) or should not (hashed dots 21) be applied, thereby maximizing the amount of information acquired.

Hence, according to the present disclosure, it is decided or weighed which pixels should be processed in a DGS filtering operation, e.g., to remove MPI from spot ToF phasor data, such that impact of noise, which reduces precision after DGS, may be mitigated by giving less or no weight to pixels with low SNR.

### Precision Filtering

In some embodiments, the time-of-flight detection circuitry is further configured to apply a precision filter.

A precision filter may be used according to the following circumstances:

In some embodiments, it may be desirable to remove low-precision depth map pixels as output by a data path of a ToF system (e.g., in full-field or spot ToF systems). In some embodiments, low SNR parts of the depth map should be invalidated (i.e., removed from the resulting point cloud), as they would contribute to increasing noise rather than adding useful points for algorithms operating on 3D data.

This may be important in applications in which noisy depth maps/point cloud data degrade quality, e.g., 3D reconstruction and/or SLAM pipelines leveraging depth data, where it may be verified that the higher the precision of point cloud data, the higher the quality of a pose tracking, dense reconstruction/meshing, and the like, of a resulting 3D model.

For example, tracking of two consecutive point clouds from the ToF system by registration via the iterative closest point (ICP) algorithm may be a task according to the present disclosure. ICP may be sensitive to high amounts of noise and outliers, and that handling outliers may increase the already relatively high complexity of the algorithm. Invalidating (e.g., removing or weighting) those parts of the point cloud that should not be accounted for is then important to minimize the errors of ICP, which may be a key part of 3D reconstruction and SLAM pipelines based on ToF data.

Knowing when the data should be removed may be considered accordingly important. In the state of the art, a common approach is to use the ToF signal amplitude or confidence. However, a high amplitude may or may not correspond to high SNR, depending on a noise regime.

Amplitude Aᵢ or reflectance ρᵢ:=AᵢDᵢ² may be used according to known methods in the following rule, and compared before an arbitrary threshold θ:

Aᵢ<θ⇒Dᵢ:=Invalid or ρᵢ<θ⇒Dᵢ:=Invalid.

However, it has been recognized that estimating the SNR and deciding whether to invalidate a depth map pixel based on the SNR may lead to more accurate results than doing so based on amplitude or confidence.

A precision filter according to the present disclosure receives the SNR as input, as returned by the aforementioned single-frame SNR estimator 15 of FIG. 2. In some embodiments, a depth noise standard deviation estimate

$${σ}_{D , i} \approx \frac{c}{4 π {f}_{m}} \cdot \frac{1}{{SNR}_{i}}$$

at pixel i is used to get a precision estimate

$${P}_{i} : = \frac{{σ}_{D , i}}{{D}_{i}}$$

yielding the invalidation rule:

Pᵢ<θ⇒Dᵢ:=Invalid.

In this case, the threshold θ is a percentage (as the precision is). This describes an embodiment of a precision filter leveraging the depth noise standard deviation estimate.

The effect of a precision filter according to the present disclosure is depicted in FIG. 8, in which, on the left, there is shown a noisy depth map, in the middle, there is shown the SNR, and on the right, a precision filtered image is shown.

When compared to amplitude or reflectance estimates, the estimation of areas that should be invalidated is more accurate according to the present disclosure, especially in those cases where the amplitude does not provide information on the actual precision of the ToF data (e.g., under high amounts of ambient light).

### Noise-Modelled Bilateral Filtering

In some embodiments, the time-of-flight detection circuitry is further configured to apply a noise-modelled bilateral filter.

A noise-modelled bilateral filter may be applied according to the following circumstances:

According to the present disclosure, SNR estimation may allow to adapt a denoising strength on depth map pixels while filtering. If the SNR is low on a large connected region of the depth map, then the parameters of the denoising algorithm may be adapted locally to increase the denoising strength.

For example, by taking a bilateral filter and related kernel-based filters, it is known to compute a local weighted average of depth map pixels in a given neighborhood of pixels (e.g., a square window). The denoising strength may be fixed in the state of the art by setting a spatial smoothing parameter σₛ and a guide smoothing parameter σ_{g}.

The spatial smoothing parameter may depend on the size of the neighborhood and may correspond to the standard deviation parameter of a Gaussian function used to weigh the pixels' distance from the center pixel i that is being denoised.

A guide smoothing parameter, which, based on a guide image (based on which values of the depth map itself may be taken for denoising), controls the computation of a weight that defines how similar pixel j is to the center pixel i, that is for example

$$Similarity ( i , j ) ∝ exp ( - \frac{{\vert {D}_{i} - {D}_{j} \vert}^{2}}{2 {σ}_{g}^{2}} )$$

with Dᵢ and Dⱼ being depth map (or, in another embodiment, phasor) values.

If there is a large amount of noise on the values one may consequently adapt (increase) the smoothing strength. However, in the state-of-the-art the choice of σ_{g} is either fixed as a constant by a predefined value depending on the use-case and/or by a fixed “preset”, or chosen by heuristics such as the signal amplitude.

According to the present disclosure, a noise-modelled bilateral filter may be provided as follows:

A denoised value \hat{D}ᵢ using a weighted average of neighboring pixels in a fixed-radius neighborhood N(i) is computed. This amounts to the filter equation

$${\hat{D}}_{i} = \frac{{\sum }_{j ∈ N ( i )} Similarity ( i , j ) {D}_{j}}{{\sum }_{j ∈ N ( i )} Similarity ( i , j )}$$

wherein similarity is chosen as above. It has been recognized that similarity can be expressed as follows:

$$Similarity ( i , j ) ∝ exp ( - \frac{{( {D}_{1} - {D}_{j} )}^{2}}{2 ( {σ}_{g}^{2} + {σ}_{{D}_{i}}^{2} + {σ}_{{D}_{j}}^{2} )} ) \cdot {δ}_{{σ}_{{D}_{i}} \approx {σ}_{{D}_{j}}}$$

so that the denoising strength can be adapted to the amount of noise per depth pixel, and so that pixels with different SNR are not mixed (i.e., as by the delta term δ_{σ}_{_{Dj}}_{≈σ}_{_{Dj}}, which is 0 when the noise variances are significantly different, and 1 otherwise).

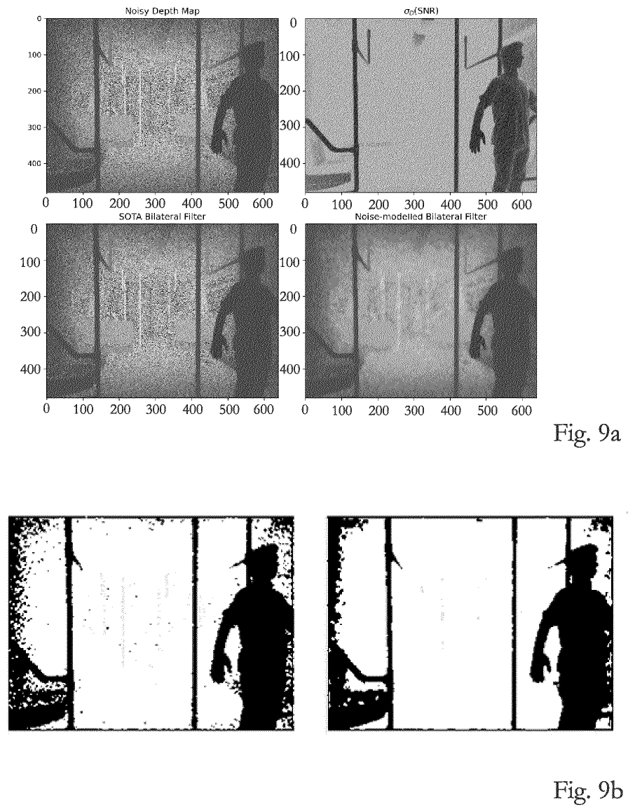

The effect of this is shown in FIGS. 9a and 9b. When compared to standard denoising estimates, the smoothing is stronger in areas where the noise variance is larger (i.e., where the SNR is lower), and the said smoothing parameter is matching the distribution of ToF depth noise in those pixels, hence tuning the adaptation to the actual amount of depth noise. This may be useful, in case of taking a heuristic

$${σ}_{g} ∝ \frac{1}{{A}_{i}}$$

will not suffice to deliver a good noise variance estimate. Such cases may include, as seen before, those where the amplitude does not provide information on the actual precision of the ToF data (e.g., under high amounts of ambient light).

More generally, pixels in kernel-based denoising filters may be weighed to adapt an amount of smoothing to an amount of noise as given by the SNR estimate. More smoothing may be applied when a pixel neighborhood has low SNR (i.e. SNR below a predetermined threshold) than when it has high SNR (i.e. SNR above a (different or same) predetermined threshold). Hence, final depth map quality may be increased by smoothing more “aggressively” on low SNR areas and depending on the instantaneous SNR estimate provided to the algorithm.

### Flow Diagrams

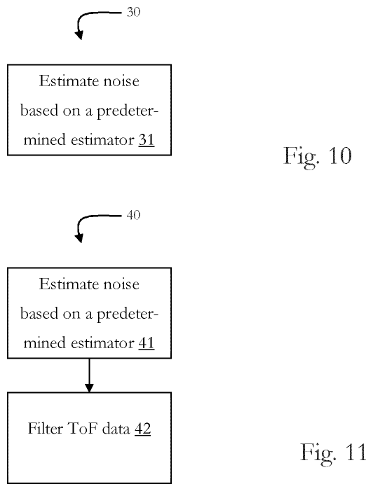

FIG. 10 depicts an embodiment of a ToF detection method 30 according to the present disclosure.

At 31, noise in time-of-flight data is estimated, wherein the time-of-flight data is indicative of one time-of-flight signal frame, wherein the estimation is based on a predetermined estimator in an estimator data path, which is provided in parallel to a standard data path, for subsequent filtering of the time-of-flight data, as discussed herein.

In this embodiment, the estimator is a single-frame estimator, as discussed above.

FIG. 11 depicts a further embodiment of a ToF detection method 40 according to the present disclosure, in which subsequent filtering is carried out compared to the method 30 of FIG. 10.

At 41, noise in time-of-flight data is estimated, wherein the time-of-flight data is indicative of one time-of-flight signal frame, wherein the estimation is based on a single-frame estimator in an estimator data path, which is provided in parallel to a standard data path, for subsequent filtering of the time-of-flight data, as discussed herein.

At 42, the ToF signal is filtered based on the estimation of the single-frame estimator, as discussed herein.

It should be understood that different filters may be used, as discussed herein, e.g. the method may further include applying a direct global separation filter and/or a precision filter and/or a noise-modelled bilateral filter.

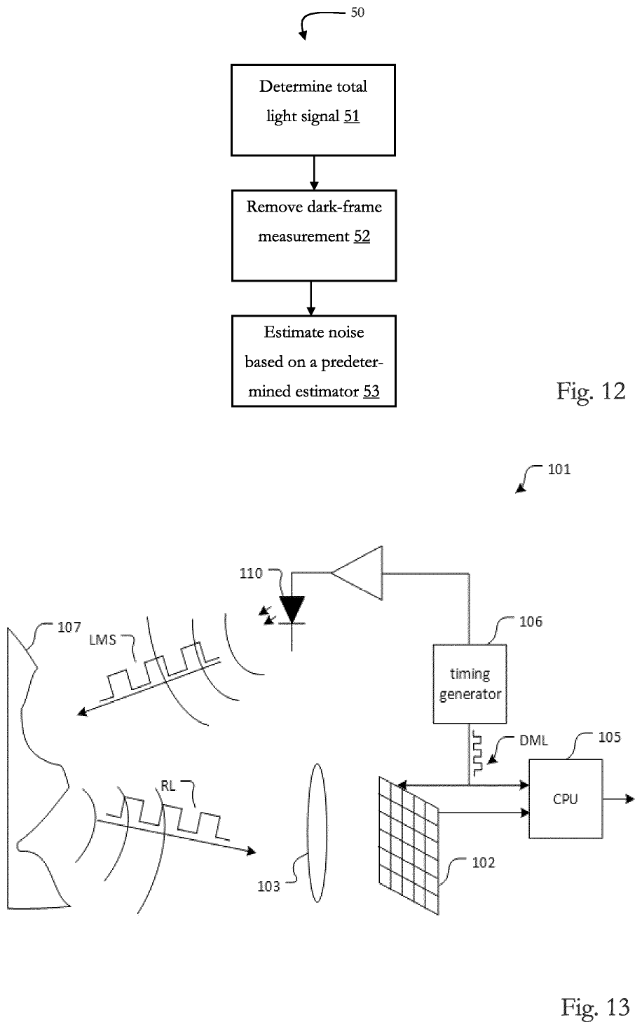

FIG. 12 depicts a further embodiment of a ToF detection method 50 according to the present disclosure, in which a total light signal is determined, and a dark-frame measurement is removed compared to the method 30 of FIG. 10.

At 51, a total light signal is determined based on a sum of tap values, as discussed herein.

At 52, a dark-frame measurement is removed, as discussed herein.

At 53, noise in time-of-flight data is estimated, wherein the time-of-flight data is indicative of one time-of-flight signal frame, wherein the estimation is based on a single-frame estimator in an estimator data path, which is provided in parallel to a standard data path, for subsequent filtering of the time-of-flight data, as discussed herein.

FIG. 13 schematically shows the operational principle of an indirect ToF imaging system 101, which can be used for depth sensing or providing a distance measurement while using the principles of the present disclosure. The iToF imaging system 101 includes an iToF camera including an imaging sensor 102 and a processor (CPU) 105 which constitutes ToF detection circuitry according to the present disclosure carrying out a ToF detection method according to the present disclosure. A scene 107 is actively illuminated with amplitude-modulated infrared light LMS at a predetermined wavelength using an illumination unit 110, for instance with some light pulses of at least one predetermined modulation frequency generated by a timing generator 106. The amplitude-modulated infrared light LMS is reflected from objects within the scene 107. A lens 103 collects reflected light RL and forms an image onto an imaging sensor 102, having an array of pixels, of the iToF camera. In indirect Time-of-Flight (iToF), the CPU 105 correlates the reflected light RL with the demodulation signal DML which yields an in-phase component value (“I value”) for each pixel and quadrature component values (“Q-value”) for each pixel, so called I and Q values, as discussed herein. Based on the I and Q values for each pixel, a phase delay value is calculated for each pixel. Based on the phase image, a depth value is determined for each pixel based on which the depth image is determined. Still further, based on the I and Q values, an amplitude value and a confidence value are determined for each pixel which is indicative of an amplitude image and a confidence image.

In a full field iToF system 101, for each pixel of the image sensor 102 a phase delay value and a depth value are determined. However, as indicated herein, the principles of the present disclosure may be applied to a spot ToF accordingly. As discussed above, in spot ToF, a scene may be illuminated with spots by a spot illuminator and the phase a value and a depth value may only be determined for (a subset of) the pixels of the image sensor 102 which capture the reflected spots from the scene.

### Implementation

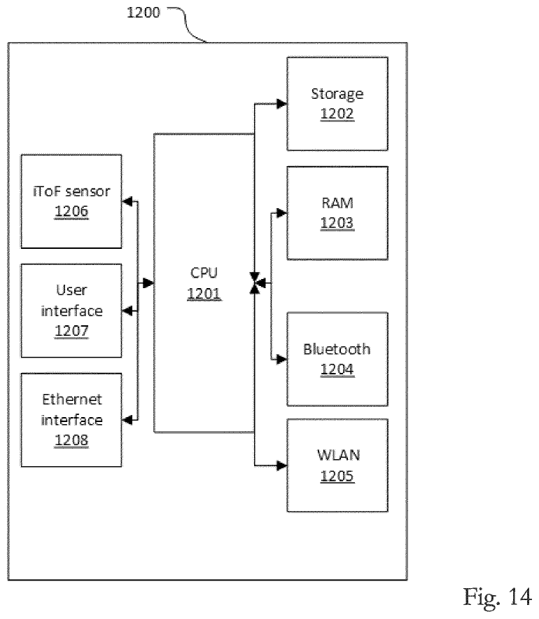

FIG. 14 schematically depicts an embodiment of an iToF device 1200 including ToF detection circuitry according to the present disclosure and configured to carry out a ToF detection method according to the present disclosure. The iToF device 1200 may further implement all other processes of a standard iToF/spot ToF system, such as I-Q value determination, phase, amplitude, confidence, reflectance determination, and the like. The iToF device is further configured to implement a DGS algorithm, as discussed herein, a filter algorithm, as discussed herein, and the like. The iToF device includes a CPU 1201 as processor. The iToF device 1200 further includes an iToF sensor 1206 configured to communicate with the processor 1201. The processor 1201 is configured to implement two parallel data paths (see FIG. 2), after which a filter is provided. The electronic device 1200 further includes a user interface 1207 configured to communicate with the processor 1201. This user interface 1207 acts as a man-machine interface and enables a dialogue between a user and the iToF device 1200. For example, the user may be able to configure the iToF device 1200 using this user interface 1207. The iToF device 1200 further includes a Bluetooth interface 1204, a WLAN interface 1205, and an Ethernet interface 1208. These units 1204, 1205, 1208 act as I/O interfaces for data communication with external devices. It should be noted that the present disclosure is not limited to these types of interfaces. On the other hand, an iToF device according to the present disclosure may only have one or two of such interfaces, e.g. only Bluetooth or only WLAN, or both. Moreover, a radio communication interface is envisaged, in some embodiments.

For example, video cameras with Ethernet, WLAN and/or Bluetooth connection may be configured to communicate with the processor 1201 via such interfaces 1204, 1205, and 1208, or via other interfaces. The electronic device 1200 further includes a data storage 1202, and a data memory 1203 (here a RAM). The data storage 1202 is arranged as a long-term storage, e.g. for storing algorithm parameters for one or more use-cases, for recording iToF sensor data obtained from the iToF sensor 1206, or the like. The data memory 1203 is arranged to temporarily store or cache data or computer instructions for processing by the processor 1201.

It should be recognized that the embodiments describe methods with an exemplary ordering of method steps. The specific ordering of method steps is however given for illustrative purposes only and should not be construed as binding. For example the ordering of 51 and 52 in the embodiment of FIG. 12 may be exchanged. Other changes of the ordering of method steps may be apparent to the skilled person.

Please note that the division of the ToF detection circuitry 10 into units 12 to 17 is only made for illustration purposes and that the present disclosure is not limited to any specific division of functions in specific units. For instance, the ToF detection circuitry 10 could be implemented by a respective programmed processor, field programmable gate array (FPGA) and the like.

In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure. Note that the present technology can also be configured as described below.
(1) Time-of-flight detection circuitry configured to determine a single-frame noise estimate (σ_{Z}²; σ_{ϕ}²; SNR; σ_{D}; σ_{D}_{ᵢ}²; σ_{D}_{ⱼ}²; O_{D}(SNR)ᵢ) based on a common mode estimator (a_{ϕ}_{ᵢ}) and a dark frame measurement (O_{dark}), and to perform filtering (17) of depth data (ϕ_{d}, θ, D, Dⱼ, Dᵢ) based on the single-frame noise estimate (σ_{Z}², σ_{ϕ}²; SNR, σ_{D} σ_{D}_{ᵢ}²; σ_{D}_{ⱼ}²; O_{D}(SNR)ᵢ).
(2) The time-of-flight detection circuitry of (1), further configured to determine a total signal (I) of a frame based on the common mode estimator (15; a_{ϕ}_{ᵢ}) of a frame and the dark frame measurement (O_{dark}), and to determine the single-frame noise estimate (σ_{Z}²; σ_{ϕ}²; SNR; σ_{D}; σ_{D}_{ᵢ}²; σ_{D}_{ⱼ}²; σ_{D}(SNR)ᵢ) based on the total signal (I) of the frame.
(3) The time-of-flight detection circuitry of (1) or (2), wherein the single-frame noise estimate (σ_{Z}²; σ_{ϕ}²; SNR; σ_{D}; σ_{D}_{ᵢ}²; σ_{D}_{ⱼ}²; σ_{D}(SNR)ᵢ) is represented by a single-frame signal-to-noise ratio (SNR), by a depth noise standard deviation (σ_{D}, σ_{ϕ}²; σ_{D}), or by a phasor variance (σ_{Z}²).

(4) The time-of-flight detection circuitry of anyone of (1) to (3), wherein the depth data (ϕ_{d}, θ, D, Dⱼ, Dᵢ) is obtained (12) from sensor raw data (T_{A,ϕ}_{₁}, T_{B,ϕ̅}_{ᵢ}).
(5) The time-of-flight detection circuitry of anyone of (1) to (4), wherein the filtering (17) of the depth data (ϕ_{d}) comprises direct-global separation filtering.
(6) The time-of-flight detection circuitry of (5), wherein direct-global separation filtering comprises filtering of the depth data (ϕ_{d}) based on the single-frame noise estimate (SNR).
(7) The time-of-flight detection circuitry of (5) or (6), wherein the direct-global separation filtering comprises determining an accuracy (a_{ϕ}).
(8) The time-of-flight detection circuitry of (7), wherein the accuracy (a_{ϕ}) is determined based on a trueness (Δϕ) value and based on the depth noise standard deviation (σ_{D}, σ_{ϕ}²).
(9) The time-of-flight detection circuitry of (8), wherein direct-global separation filtering is carried out based on a comparison of the accuracy without direct-global separation (a_{ϕ}^{No DGS}) with the accuracy with direct-global separation (a_{ϕ}^{DGS})
(10) The time-of-flight detection circuitry of anyone of (1) to (9), wherein the filtering (17) of the depth data (Dᵢ) comprises precision filtering.
(11) The time-of-flight detection circuitry of (10), wherein the precision filtering comprises filtering of the depth data (Dᵢ) based on the single-frame noise estimate (σ_{D}(SNR)ᵢ).
(12) The time-of-flight detection circuitry of (10) or (11), wherein the precision filter is applied based on a precision estimate (Pᵢ).
(13) The time-of-flight detection circuitry of (12), wherein the precision estimate (Pᵢ) is based on a relation between the depth noise standard deviation (σ_{D}(SNR)ᵢ) and the depth data (Dᵢ).
(14) The time-of-flight detection circuitry of (12) or (13), wherein the precision filtering comprises invalidating depth data based on the precision estimate (Pᵢ).
(15) The time-of-flight detection circuitry of anyone of (1) to (14), wherein the filtering (17) of the depth data (Dⱼ, Dᵢ) comprises noise-modelled bilateral filtering.
(16) The time-of-flight detection circuitry of (15), wherein the noise-modelled bilateral filtering comprises determining a denoised depth value (\hat{D}ᵢ) based on a similarity.
(17) The time-of-flight detection circuitry of (16), wherein the similarity is determined based on a weighted average of neighboring pixels in a predetermined radius (N(i)).
(18) The time-of-flight detection circuitry of (16) or (17), wherein the similarity is determined based on the single-frame noise estimate (σ_{D}_{ᵢ}²; σ_{D}_{ⱼ}²).
(19) A time-of-flight detection method comprising:
   determining a single-frame noise estimate (σ_{Z}²; σ_{ϕ}²; SNR; σ_{D}; σ_{D}_{ᵢ}²; σ_{D}_{ⱼ}²; σ_{D}(SNR)ᵢ) based on a common mode estimator (15; a_{ϕ}_{ᵢ}) and a dark frame measurement (O_{dark});
   and filtering (17) of depth data (ϕ_{d}, θ, D, Dⱼ, Dᵢ) based on the single-frame noise estimate (σ_{Z}²; σ_{ϕ}²; SNR; σ_{D}; σ_{D}_{ᵢ}²; σ_{D}_{ⱼ}²; σ_{D}(SNR)ᵢ).
(20) A computer program comprising program code causing a computer to perform the method according to (19), when being carried out on a computer.
(21) A non-transitory computer-readable recording medium that stores therein a computer program product, which, when executed by a processor, causes the method according to (19) to be performed.

1. Time-of-flight detection circuitry configured to determine a single-frame noise estimate based on a common mode estimator and a dark frame measurement, and to perform filtering of depth data based on the single-frame noise estimate.

2. The time-of-flight detection circuitry of claim 1, further configured to determine a total signal of a frame based on the common mode estimator of a frame and the dark frame measurement, and to determine the single-frame noise estimate based on the total signal of the frame.

3. The time-of-flight detection circuitry of claim 1, wherein the single-frame noise estimate is represented by a single-frame signal-to-noise ratio, by a depth noise standard deviation, or by a phasor variance.

4. The time-of-flight detection circuitry of claim 1, wherein the depth data is obtained from sensor raw data.

5. The time-of-flight detection circuitry of claim 1, wherein the filtering of the depth data comprises direct-global separation filtering.

6. The time-of-flight detection circuitry of claim 5, wherein direct-global separation filtering comprises filtering of the depth data based on the single-frame noise estimate.

7. The time-of-flight detection circuitry of claim 5, wherein the direct-global separation filtering comprises determining an accuracy.

8. The time-of-flight detection circuitry of claim 7, wherein the accuracy is determined based on a trueness value and based on the depth noise standard deviation.

9. The time-of-flight detection circuitry of claim 8, wherein direct-global separation filtering is carried out based on a comparison of the accuracy without direct-global separation with the accuracy with direct-global separation.

10. The time-of-flight detection circuitry of claim 1, wherein the filtering of the depth data comprises precision filtering.

11. The time-of-flight detection circuitry of claim 10, wherein the precision filtering comprises filtering of the depth data based on the single-frame noise estimate.

12. The time-of-flight detection circuitry of claim 10, wherein the precision filter is applied based on a precision estimate.

13. The time-of-flight detection circuitry of claim 12, wherein the precision estimate is based on a relation between the depth noise standard deviation and the depth data.

14. The time-of-flight detection circuitry of claim 12, wherein the precision filtering comprises invalidating depth data based on the precision estimate.

15. The time-of-flight detection circuitry of claim 1, wherein the filtering of the depth data comprises noise-modelled bilateral filtering.

16. The time-of-flight detection circuitry of claim 15, wherein the noise-modelled bilateral filtering comprises determining a denoised depth value based on a similarity.

17. The time-of-flight detection circuitry of claim 16, wherein the similarity is determined based on a weighted average of neighboring pixels in a predetermined radius.

18. The time-of-flight detection circuitry of claim 16, wherein the similarity is determined based on the single-frame noise estimate.

19. A time-of-flight detection method comprising:
determining a single-frame noise estimate based on a common mode estimator and a dark frame measurement;
and filtering of depth data based on the single-frame noise estimate.
